(19) United States
(12) Patent Application Publication
(10) Pub. No.: US 2013/0342549 A1
(43) Pub. Date: Dec. 26, 2013

(54) APPARATUS AND METHOD FOR PROCESSING RENDERING DATA

(71) Applicant: Samsung Electronics Co., Ltd., Suwon (KR)

(72) Inventors: Jae Don LEE, Yongin (KR); Min Kyu JEONG, Yongin (KR); Min Young SON, Hwaseong (KR); Shi Hwa LEE, Seoul (KR); Seung Won LEE, Hwaseong (KR)

(21) Appl. No.: 13/918,210

(22) Filed: Jun. 14, 2013

(30) Foreign Application Priority Data
Jun. 26, 2012 (KR) 10-2012-0068449

(51) Int. Cl. G06T 15/80

(52) U.S. Cl. CPC G06T 15/80
USPC 345/522

(57) ABSTRACT

An apparatus and method for processing rendering data that may group vertex data that is received from a host computer, and may assign a shader processing unit to process a vertex shader among one or more shader processing units, and process the grouped vertex data using the assigned shader processing unit.

### CROSS-REFERENCE TO RELATED APPLICATIONS

This application claims the priority benefit of Korean Patent Application No. 10-2012-0068449, filed on Jun. 26, 2012, in the Korean Intellectual Property Office, the disclosure of which is incorporated herein by reference.

### BACKGROUND

1. Field

One or more example embodiments of the following disclosure relate to an apparatus and method for grouping and processing data in a rendering system.

2. Description of the Related Art

In the case of employing a fixed graphics pipeline, three-dimensional (3D) rendering hardware may process all of the applications using a fixed rendering process.

In this case, the rendering hardware may have no choice but to display a similar screen due to constraints in expression.

The rendering hardware may require a function capable of replacing a portion of the fixed graphics pipeline with a program created by an application developer. The above function may be configured using a programmable shader.

The programmable shader may generally refer to a constituent element programmable in a graphics pipeline that is generated to provide flexibility to a 3D graphics pipeline.

For example, the programmable shader may be a vertex shader, a geometry shader, a pixel shader, and the like.

A graphics pipeline is programmable of the rendering hardware to which the programmable shader is applied, and thus, a graphics processing unit (GPU) may need to change a shader program that operates in the GPU in response to a request of an application program. Due to the above program change work, performance may be degraded.

Further, the number of shader programs may increase according to an increase in complexity of a screen to be rendered by the application program. Performance of the GPU may be affected by frequent replacement of a shader program.

### SUMMARY

The foregoing and/or other aspects are achieved by providing an apparatus for processing rendering data, the apparatus including a vertex loader to group vertex data that is received from a host computer; and a work scheduler to assign a shader processing unit to process a vertex shader among one or more shader processing units, and to process the grouped vertex data using the assigned shader processing unit.

The host computer may include an application executor to determine whether to execute a three-dimensional (3D) application, and a device driver to transmit the vertex data to the vertex loader.

The rendering data processing apparatus may further include a tile generator to group the processed vertex data based on a tile unit.

The rendering data processing apparatus may further include a fragment generator to generate fragment data by reading a primitive list based on the tile unit.

The fragment generator may generate only fragment data to be output on a screen.

The fragment generator may group the generated fragment data according to a shader program.

The work scheduler may assign a shader processing unit to process the fragment data among the one or more shader processing units, and may process the grouped fragment data using the assigned shader processing unit.

The rendering data processing apparatus may further include a raster operation unit to generate a pixel to be finally output based on the processed fragment data.

The foregoing and/or other aspects are achieved by providing an apparatus for processing rendering data, the apparatus including a fragment generator to generate fragment data from vertex data that is received from a host computer and thereby is processed, and to group the generated fragment data, and a work scheduler to assign a shader processing unit to process the fragment data among one or more shader processing units, and to process the grouped fragment data using the assigned shader processing unit.

The foregoing and/or other aspects are achieved by providing a method of processing rendering data, the method including grouping vertex data that is received from a host computer, assigning a shader processing unit to process a vertex shader among one or more shader processing units, and processing the grouped vertex data using the assigned shader processing unit.

The foregoing and/or other aspects are achieved by providing a method of processing rendering data, the method including generating fragment data from vertex data that is received from a host computer and thereby is processed, to group the generated fragment data, assigning a shader processing unit to process the fragment data among one or more shader processing units, and processing the grouped fragment data using the assigned shader processing unit.

The foregoing and/or other aspects are achieved by providing a method of processing rendering data, the method including: grouping vertex data that utilizes the same vertex shader program; assigning a shader processing unit to process the grouped vertex data through a work queue; and processing the grouped vertex data using the assigned shader processing unit.

The grouping of fragment data may include grouping fragment data that utilizes the same pixel shader program.

Rendering data may be distributed to one or more shader processing units.

The rendering data processing apparatus may reduce a number of times that a shader program is changed in a shader core.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an exemplary configuration of a rendering data processing system, according to an example embodiment;

FIG. 2 illustrates an exemplary configuration of a rendering data processing system, according to another example embodiment;

FIG. 3 illustrates an exemplary configuration of a rendering data processing system, according to still another example embodiment;

FIG. 4 illustrates an example of assigning, using a work scheduler, a processing unit to process rendering data, according to an example embodiment;

FIG. 5 illustrates an example of grouping fragment data, according to an example embodiment;

FIG. 6 illustrates an example of grouping vertex data, according to an example embodiment;

FIG. 7 illustrates an example of performing, by a rendering data processing apparatus, pixel scan line processing, according to an example embodiment;

FIG. 8 illustrates an example of performing, by a rendering data processing apparatus, primitive unit processing according to an example embodiment;

FIG. 9 illustrates an example of performing, by a rendering data processing apparatus, pixel grouping processing, according to an example embodiment;

FIG. 10 illustrates a method of processing rendering data, according to an example embodiment; and

FIG. 11 illustrates a method of processing rendering data, according to another example embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

Terminologies used herein are defined to appropriately describe the embodiments and thus, may be changed depending on a user, the intent of an operator, or a custom. Accordingly, the terminologies must be defined based on the following overall description.

A rendering data processing apparatus, according to an example embodiment of the present disclosure, may be applied to three-dimensional (3D) rendering hardware to thereby replace a portion of a programmable graphics pipeline with a program created by an application developer.

The rendering data processing apparatus may provide flexibility to a 3D graphics pipeline to perform a rendering operation desired by a programmer.

A programmable shader used herein may generally refer to a constituent element that is programmable in a graphics pipeline.

For example, the programmable shader may be a vertex shader, a geometry shader, or a pixel shader, and the like.

According to an example embodiment, the rendering data processing apparatus may reduce the number of context switches of a graphics processing unit (GPU) that operates a pixel shader during a 3D rendering process.

The rendering data processing apparatus may group and process vertex data that is input by an application program, based on vertex data that utilizes the same vertex shader program.

Further, the rendering data processing apparatus may group and process fragment data that is generated by a rasterizer, based on fragment data that utilizes the same pixel shader program.

Moreover, the rendering data processing apparatus may group vertex data using a device driver of a host computer or a vertex loader of a graphics subsystem, and may process the grouped vertex data using an assigned shader processing unit.

Additionally, the rendering data processing apparatus may group pixel data using a fragment generator of a graphics subsystem, and may process the grouped pixel data using an assigned processing unit.

Also, the rendering data processing apparatus may assign a shader processing unit capable of processing grouped vertex data or grouped pixel data through a work queue.

Hereinafter, an apparatus and method for grouping and processing rendering data will be described with reference to the accompanying drawings.

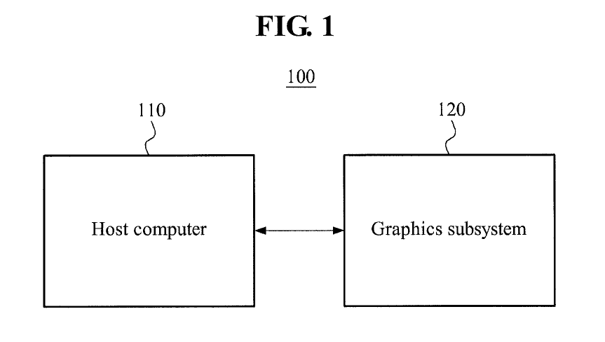

FIG. 1 illustrates an exemplary configuration of a rendering data processing system 100, according to an example embodiment.

Referring to FIG. 1, a graphics subsystem 120 of the rendering data processing system may receive rendering data from a host computer 110, and may assign a shader processing unit (shown in other figures) to process the same shader program.

The graphics subsystem 120 may integrally process grouped rendering data using the assigned shader processing unit.

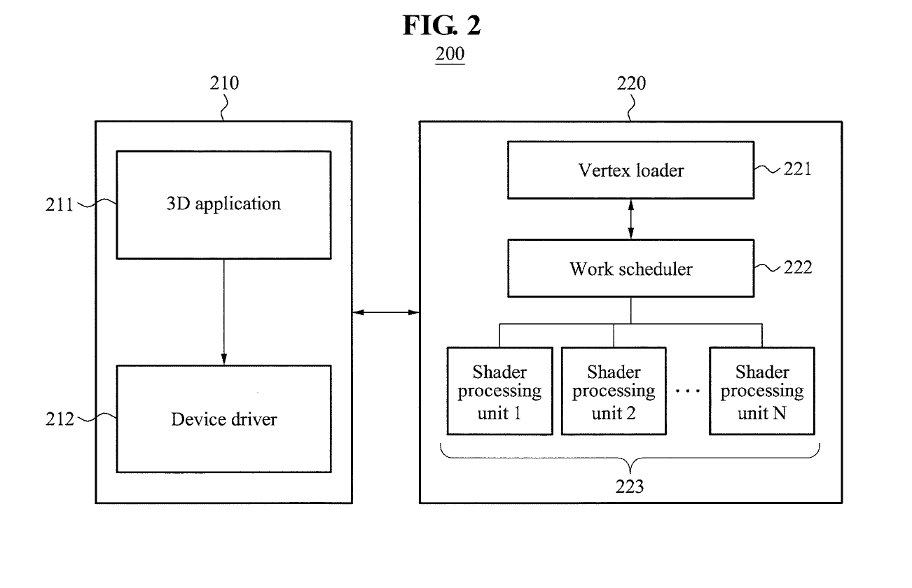

FIG. 2 illustrates an exemplary configuration of a rendering data processing system 200, according to another example embodiment.

Referring to FIG. 2, in the case of executing a 3D application 211, a host computer 210 may transfer rendering data to a graphics subsystem 220 of a GPU through a device driver 212 in order to process a rendering operation.

The graphics subsystem 220 may receive the rendering data from the host computer 210, may assign a processing unit to process the same shader program, and may integrally process grouped rendering data using the assigned processing unit.

Hereinafter, as an example, the graphics subsystem 220 will be further described by assuming the graphics subsystem 220 as a rendering data processing apparatus. However, this assumption is exemplary, and thus, the present disclosure is not limited thereto.

According to an aspect of the present disclosure, the rendering data processing apparatus may perform scheduling of a processing unit that processes a shader program in the GPU.

Referring again to FIG. 2, the rendering data processing apparatus 220 may include a vertex loader 221 to group vertex data that is received from the host computer 210.

The rendering data processing apparatus 220 may assign a shader processing unit, among one or more shader processing units 223, to process a vertex shader, for example, a shader processing unit 1, a shader processing unit 2, and a shader processing unit N, and so on, using a work scheduler 222.

The work scheduler 222 of the rendering data processing apparatus 220 may process the grouped vertex data using the assigned shader processing unit.

The rendering data processing apparatus 220 may group and process vertex data that is input by an application program, based on vertex data that utilizes the same vertex shader program.

Further, the rendering data processing apparatus 220 may group and process fragment data that is generated by a rasterizer, based on fragment data that utilizes the same pixel shader program.

Depending on embodiments, the device driver 212 of the host computer 210 may be used to group the vertex data. In other embodiments, the rendering data processing apparatus 220 may group the vertex data using the vertex loader 221. Further, the rendering data processing apparatus 220 may process the grouped vertex data using an assigned processing unit.

Hereinafter, a method of grouping, by a rendering data processing apparatus, for example, the rendering data processing apparatus 220, and processing rendering data that utilizes the same vertex shader program or the same pixel shader program according to an embodiment will be described.

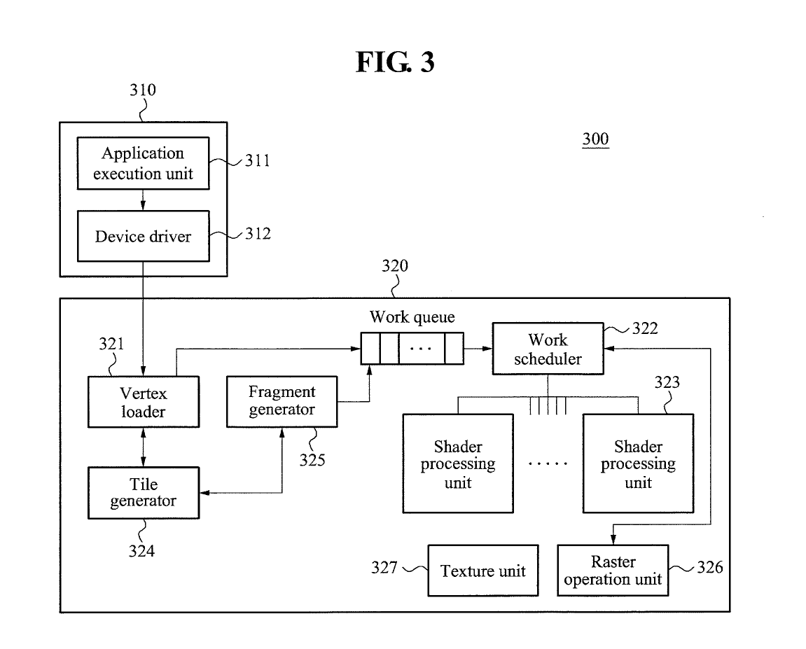

FIG. 3 illustrates an exemplary configuration of a rendering data processing system 300, according to still another example embodiment.

Hereinafter, a graphics subsystem 320 will be further described by assuming the graphics subsystem 320 as a rendering data processing apparatus.

Referring to FIG. 3, the rendering data processing apparatus 320 may group vertex data that is received from a host computer 310, using a vertex loader 321.

The host computer 310 may include an application execution unit 311 to determine whether to execute a 3D application and a device driver 312 to transmit vertex data to the vertex loader 321. Again, depending on embodiments, the device driver 312 of the host computer 310 may be used to group the vertex data.

The rendering data processing apparatus 320 may assign a shader processing unit, among one or more shader processing units 323, to process a vertex shader, using a work scheduler 322.

For example, the rendering data processing apparatus 320 may assign the shader processing unit 323 capable of processing grouped vertex data through a work queue.

The work scheduler 322 of the rendering data processing apparatus 320 may process the grouped vertex data using the assigned shader processing unit 323.

In addition, the rendering data processing apparatus 320 may group the processed vertex data based on a tile unit using a tile generator 324.

The rendering data processing apparatus 320 may generate fragment data by reading a primitive list based on the tile unit using a fragment generator 325.

The fragment data may correspond to graphics pixel data of rendering data, however, the present disclosure is not limited thereto.

The fragment generator 325 may generate only fragment data to be output on a screen.

The fragment generator 325 may generate only pixel data to be output on the screen.

The fragment generator 325 may group the generated fragment data, according to a shader program. That is, the rendering data processing apparatus may group and process fragment data that is generated, based on fragment data that utilizes the same pixel shader program.

The rendering data processing apparatus 320 may assign the shader processing unit, among the one or more shader processing units 323, to process the fragment data, using the work scheduler 322.

The work scheduler 322 may process the grouped fragment data using the assigned shader processing unit 323.

The rendering data processing apparatus 320 may generate a pixel to be finally output based on the processed fragment data, using a raster operation unit 326.

The rendering data processing apparatus 320 may overlay texture on the fragment data using a texture unit 327.

The rendering data processing apparatus 320 may display a generated pixel using a display unit (not shown).

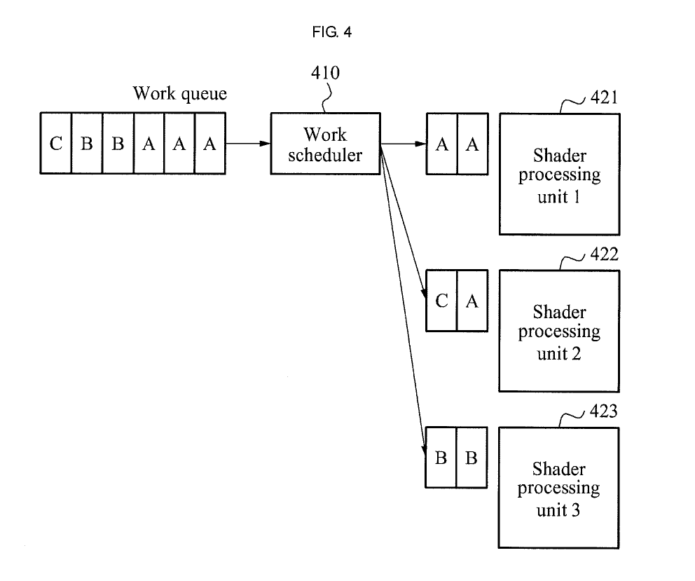

FIG. 4 illustrates an example of assigning, using a work scheduler 410, a processing unit to process rendering data, according to an example embodiment.

Referring to FIG. 4, the work scheduler 410 may distribute rendering data to one or more shader processing units, for example, a shader processing unit 1 (421), a shader processing unit 2 (422), and a shader processing unit 3 (423). However, the use of three shader processing units is exemplary, and thus, the present disclosure is not limited thereto.

The work scheduler 410 may assign, to the same shader processing units 421-423, works that utilize the same shader program. For example, in FIG. 4, the work scheduler 410 assigns data represented by AA to shader processing unit 1.

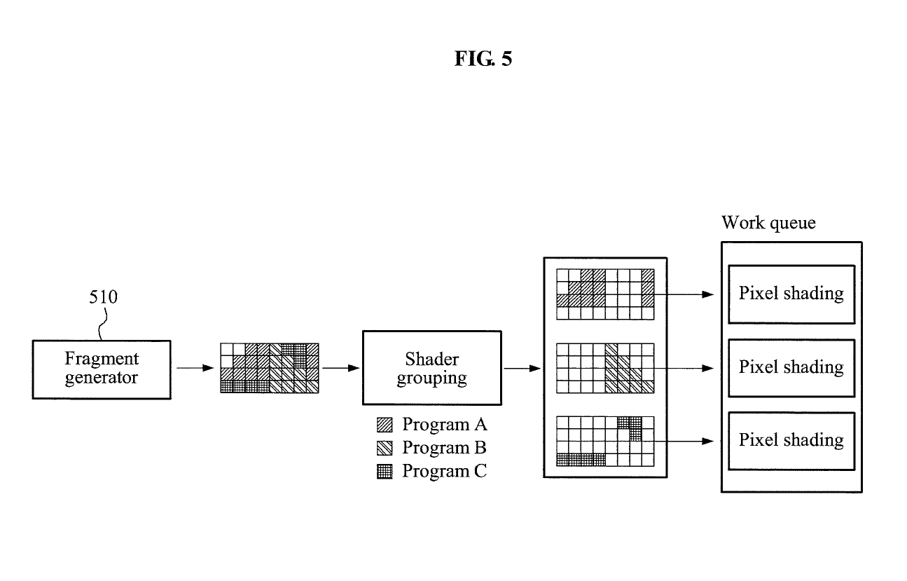

FIG. 5 illustrates an example of grouping fragment data, according to an example embodiment.

Referring to FIG. 5, a fragment generator 510 may generate fragment data.

In the generated fragment data, only fragment data to be output on an actual screen may be filtered through a visibility test, for example.

A rendering data processing apparatus, according to an aspect of the present disclosure, may group the fragment data based on fragment data that utilizes the same pixel shader program, and may send the grouped fragment data to a work queue. For example, in FIG. 5, the generated fragment data is grouped by Program A, Program B, and Program C.

A work scheduler may assign a shader processing unit corresponding to a corresponding work and may execute a pixel shader program.

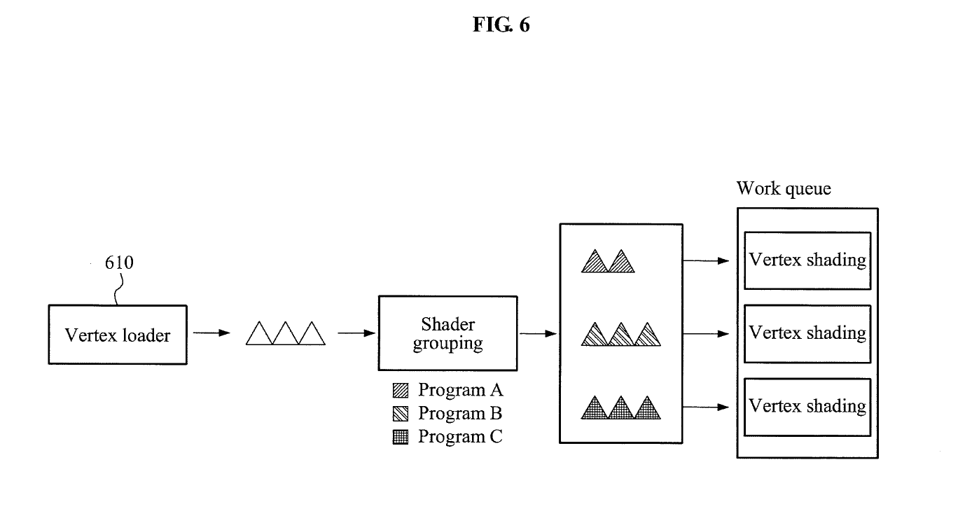

FIG. 6 illustrates an example of grouping vertex data, according to an example embodiment.

Referring to FIG. 6, a vertex loader 610 may group vertex data that is received from a host computer, based on vertex data that utilizes the same shader program, and may send the grouped vertex data to a work queue.

A work scheduler may assign a shader processing unit corresponding to a corresponding work and may execute a vertex shader program.

Depending on embodiments, the host computer may perform an operation of grouping vertex data that utilizes the same vertex shader program, using a device driver.

A rendering data processing apparatus, according to an aspect of the present disclosure, may reduce the number of times that a shader program is changed in a shader core.

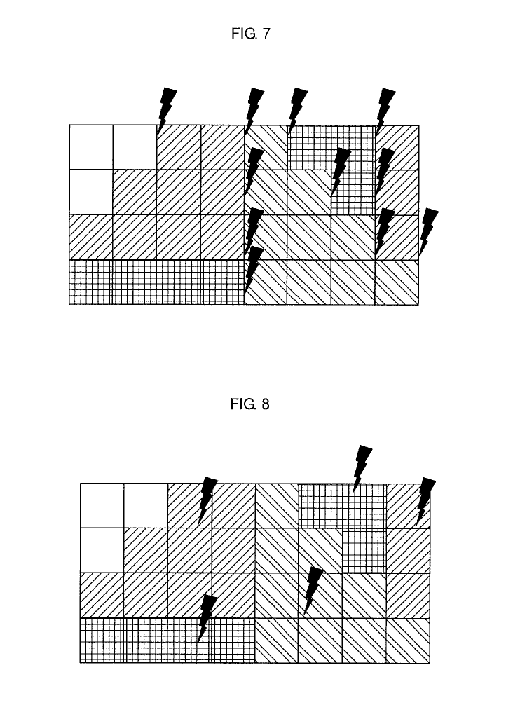

FIG. 7 illustrates an example of performing, by a rendering data processing apparatus, pixel scan line processing, according to an example embodiment.

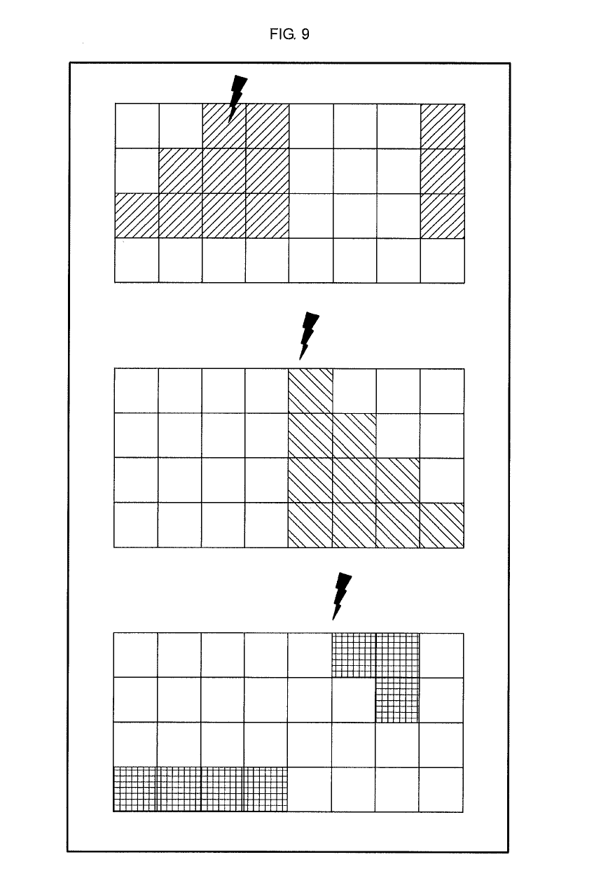

FIG. 8 illustrates an example of performing, by a rendering data processing apparatus, primitive unit processing, according to an example embodiment.

FIG. 9 illustrates an example of performing, by a rendering data processing apparatus, pixel grouping processing, according to an example embodiment.

Referring to FIG. 7 through FIG. 9, according to embodiments, in the case of processing rendering data based on a scan line (as in FIG. 7) and a primitive unit (as in FIG. 8), the rendering data processing apparatus may need to change a shader program eleven times and five times, respectively. For example, in FIG. 7, the solid bolt symbol may indicate a change in shader program when rendering data is processed based on a scan line. In the case of performing pixel grouping processing (as in FIG. 9), the rendering data processing apparatus may perform processing by changing a shader program only three times.

The rendering data processing apparatus may group and process fragment data by scheduling a processing unit that processes a shader program.

Hereinafter, a method of grouping and processing fragment data will be described.

Referring again to FIG. 1, the graphics subsystem 120 of the rendering data processing system may receive rendering data from the host computer 110.

The graphics subsystem 120 may generate fragment data from the rendering data and group the generated fragment data. Further, the graphics subsystem 120 may assign a processing unit to process the same shader program.

The graphics subsystem 120 may integrally process the grouped fragment data using the assigned processing unit.

Referring again to FIG. 2, the rendering data processing apparatus 220 may group vertex data that is received from the host computer 210, using the vertex loader 221

The rendering data processing apparatus 220 may process the grouped vertex data using the work scheduler 222.

According to an aspect of the present disclosure, a rendering data processing apparatus may group pixel data using a fragment generator of a graphics subsystem, and may process the grouped pixel data using an assigned processing unit.

Referring again to FIG. 3, the host computer 310 may include the application execution unit 311 to determine whether to execute a 3D application and the device driver 312 to transmit vertex data to the vertex loader 321.

The rendering data processing apparatus 320 may group vertex data that is received from the host computer 310 and then is processed, using the tile generator 324.

The rendering data processing apparatus 320 may group the processed vertex data based on a tile unit, using the tile generator 324.

The rendering data processing apparatus 320 may generate fragment data from the grouped vertex data, using the fragment generator 325.

The rendering data processing apparatus 320 may generate fragment data by reading a primitive list based on the tile unit using the fragment generator 325.

The fragment generator 325 may generate only fragment data to be output on a screen.

The rendering data processing apparatus 320 may generate fragment data from vertex data that is received from the host computer 310 and then is processed, using the fragment generator 325, and may group the generated fragment data.

The fragment generator 325 may group the generated fragment data, according to a shader program.

The rendering data processing apparatus 320 may assign a shader processing unit to process the fragment data among the one or more shader processing units 323, using the work scheduler 322.

The rendering data processing apparatus 320 may assign the shader processing unit capable of processing the grouped fragment data through a work queue.

The work scheduler 322 of the rendering data processing apparatus 320 may process the grouped fragment data using work scheduler 322 and the assigned shader processing unit 323.

The rendering data processing apparatus 320 may generate a pixel to be finally output based on the processed fragment data, using the raster operation unit 326.

The rendering data processing apparatus 320 may output the generated pixel using the display unit (not shown).

Referring again to FIG. 5, the fragment generator 510 may generate fragment data.

In the generated fragment data, only fragment data to be output on an actual screen may be filtered through a visibility test.

A rendering data processing apparatus, according to an aspect of the present disclosure, may group the fragment data based on fragment data that utilizes the same pixel shader program, and may send the grouped fragment data to a work queue.

A work scheduler may assign a shader processing unit corresponding to a corresponding work and may execute a pixel shader program.

The rendering data processing apparatus may reduce the number of times that a shader program is changed in a shader core.

The rendering data processing apparatus may reduce the number of context switches of a GPU that operates a pixel shader during a 3D rendering process.

The rendering data processing apparatus may group and process fragment data that is generated by a rasterizer, based on fragment data that utilizes the same pixel shader program.

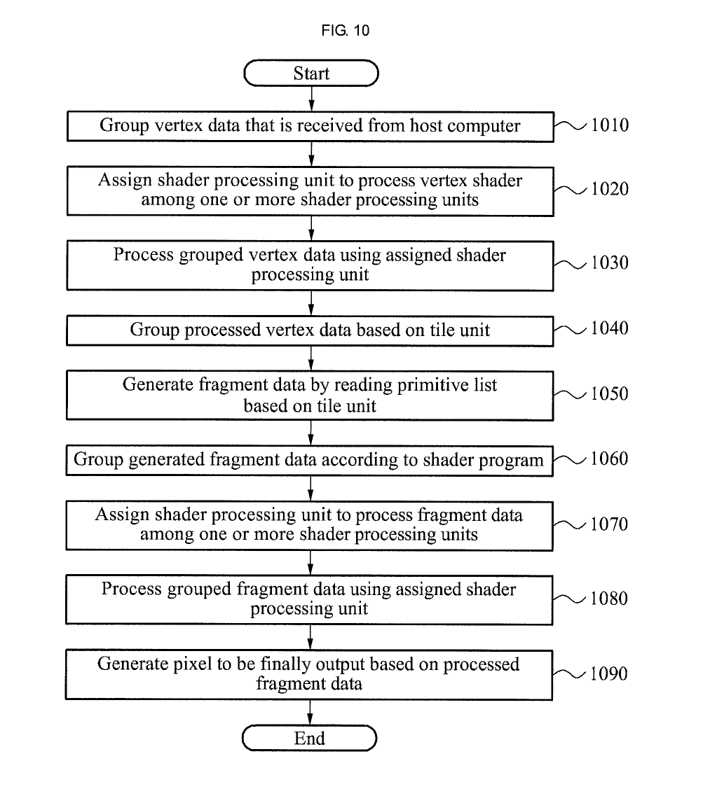

FIG. 10 illustrates an exemplary method of processing rendering data, according to an example embodiment.

Referring to FIG. 10, in operation 1010, a rendering data processing apparatus according to an embodiment may group vertex data that is received from a host computer.

In operation 1020, the rendering data processing apparatus may assign a shader processing unit to process a vertex shader among one or more shader processing units.

In operation 1030, the rendering data processing apparatus may process the grouped vertex data using the assigned shader processing unit.

In operation 1040, the rendering data processing apparatus may group the processed vertex data based on a tile unit.

In operation 1050, the rendering data processing apparatus may generate fragment data by reading a primitive list based on the tile unit.

In operation 1060, the rendering data processing apparatus may group the generated fragment data, according to a shader program.

In operation 1070, the rendering data processing apparatus may assign a shader processing unit to process the fragment data among the one or more shader processing units.

In operation 1080, the rendering data processing apparatus may process the grouped fragment data using the assigned shader processing unit.

In operation 1090, the rendering data processing apparatus may generate a pixel to be finally output based on the processed fragment data.

According to an aspect of the present disclosure, the rendering data processing method may reduce the number of context switches of a GPU that operates a pixel shader during a 3D rendering process.

According to an aspect of the present disclosure, the rendering data processing method may group and process vertex data input by an application program, based on vertex data that utilizes the same vertex shader program.

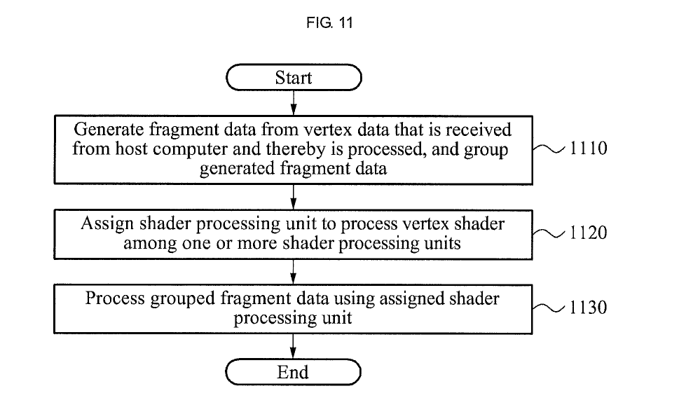

FIG. 11 illustrates an exemplary method of processing rendering data, according to another example embodiment.

Referring to FIG. 11, in operation 1110, a rendering data processing apparatus according to an example embodiment may generate fragment data from vertex data that is received from a host computer and thereby is processed, and may group the generated fragment data.

In operation 1120, the rendering data processing apparatus may assign a shader processing unit to process the fragment data among one or more shader processing units.

In operation 1130, the rendering data processing apparatus may process the grouped fragment data using the assigned shader processing unit.

According to an aspect of the present disclosure, the rendering data processing apparatus may generate a pixel to be finally output based on the processed fragment data.

According to an aspect of the present disclosure, the rendering data processing method may reduce the number of context switches of a GPU that operates a pixel shader during a 3D rendering process.

According to an aspect of the present disclosure, the rendering data processing method may group and process fragment data that is generated by a rasterizer, based on fragment data that utilizes the same pixel shader program.

According to an aspect of the present disclosure, the rendering data processing apparatus may be applied to 3D rendering hardware to thereby replace a portion of a programmable graphics pipeline with a program created by an application developer.

According to an aspect of the present disclosure, the rendering data processing apparatus may provide flexibility to a 3D graphics pipeline to perform a rendering operation desired by a programmer.

The rendering data processing method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Further, according to an aspect of the embodiments, any combinations of the described features, functions and/or operations can be provided.

Moreover, the rendering data processing apparatus, as discussed above, may include at least one processor to execute at least one of the above-described units and methods.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An apparatus for processing rendering data, the apparatus comprising:
a vertex loader to group vertex data that is received from a host computer; and
a work scheduler to assign a shader processing unit, among one or more shader processing units, for processing a vertex shader, and to process the grouped vertex data using the assigned shader processing unit.

2. The apparatus of claim 1, wherein the host computer comprises:
an application executor to determine whether to execute a three-dimensional (3D) application; and
a device driver to transmit the vertex data to the vertex loader.

3. The apparatus of claim 2, wherein the device driver of the host computer groups the vertex data.

4. The apparatus of claim 1, wherein the vertex data is grouped based on vertex data that utilizes the same vertex shader.

5. The apparatus of claim 1, further comprising:
a tile generator to group the processed vertex data based on a tile unit.

6. The apparatus of claim 5, further comprising:
a fragment generator to generate fragment data by reading a primitive list based on the tile unit.

7. The apparatus of claim 6, wherein the fragment generator generates fragment data to be output on a screen.

8. The apparatus of claim 6, wherein the fragment generator groups the generated fragment data according to a shader program.

9. The apparatus of claim 8, wherein the work scheduler assigns a shader processing unit for processing the fragment data among the one or more shader processing units, and processes the grouped fragment data using the shader processing unit assigned for processing the fragment data.

10. The apparatus of claim 9, further comprising:
a raster operation unit to generate a pixel to be finally output based on the processed fragment data.

11. An apparatus for processing rendering data, the apparatus comprising:
a fragment generator to generate fragment data from vertex data that is received from a host computer and then is processed, and to group the generated fragment data; and
a work scheduler to assign a shader processing unit, among one or more shader processing units, for processing the fragment data, and to process the grouped fragment data using the assigned shader processing unit.

12. A method of processing rendering data, the method comprising:
grouping vertex data received from a host computer;
assigning a shader processing unit, among one or more shader processing units, for processing a vertex shader; and
processing the grouped vertex data using the assigned shader processing unit.

13. The method of claim 12, further comprising:
grouping the processed vertex data based on a tile unit.

14. The method of claim 13, further comprising:
generating fragment data by reading a primitive list based on the tile unit.

15. The method of claim 14, further comprising:
grouping the generated fragment data according to a shader program.

16. The method of claim 15, further comprising:
assigning a shader processing unit to process the fragment data among the one or more shader processing units; and
processing the grouped fragment data using the assigned shader processing unit.

17. The method of claim 16, further comprising:
generating a pixel to be finally output based on the processed fragment data.

18. A method of processing rendering data, the method comprising:
generating fragment data from vertex data that is received from a host computer and thereby is processed, to group the generated fragment data;
assigning a shader processing unit to process the fragment data among one or more shader processing units; and
processing the grouped fragment data using the assigned shader processing unit.

19. A non-transitory computer-readable medium comprising a program for instructing a computer to perform the method of claim 12.

20. A method of processing rendering data, the method comprising:
grouping vertex data that utilizes the same vertex shader program;
assigning a shader processing unit to process the grouped vertex data through a work queue; and
processing the grouped vertex data using the assigned shader processing unit.
